(19) United States
(12) Patent Application Publication
(10) Pub. No.: US 2017/0293863 A1
(43) Pub. Date: Oct. 12, 2017

(54) DATA ANALYSIS SYSTEM, AND CONTROL METHOD, PROGRAM, AND RECORDING MEDIUM THEREFOR

(71) Applicant: FRONTEO, Inc., Tokyo (JP)

(72) Inventor: Kazumi HASUKO, Tokyo (JP)

(21) Appl. No.: 15/482,401

(22) Filed: Apr. 7, 2017

(30) Foreign Application Priority Data
Apr. 8, 2016 (JP) 2016-078175

(51) Int. Cl. G06N 99/00

(52) U.S. Cl. CPC G06N 99/005

(57) ABSTRACT

The present invention relates to data analysis whereby a plurality of components are extracted from learning data, each of the plurality of components constituting at least part of the learning data; a component to be utilized for evaluation of the plurality of pieces of evaluation data is selected, from among the plurality of components, on the basis of evaluation information about each of the plurality of extracted components; and the evaluation data is evaluated by utilizing the selected component.

### BACKGROUND OF THE INVENTION

### Field of the Invention

The present invention relates to a data analysis system and the like for analyzing data, which can be applied to, for example, a system including an artificial intelligence for analyzing big data.

### Description of Related Art

As a result of development of information-oriented society along with the development of computers, big data has been widely and closely related to corporate and personal activities. Therefore, there is a great demand for accurate sorting out of desired information from big data in recent years.

As an approach for retrieving desired information from big data, a system is known in which a reviewer classifies a plurality of pieces of reference data in terms of whether the data is relevant to a predetermined case or not and analysis target data is automatically classified using the result of the classification (e.g., Japanese Patent Laid-Open No. 2013-182338).

### SUMMARY OF THE INVENTION

According to the data analysis system of the related art, data related to a predetermined case can be found out from a huge amount of data. However, there have been some problems with such data analysis system that even if the degree of relevance of data to a predetermined case is not originally high, the data may be evaluated as data highly relevant to the predetermined case, or the converse situation may occur. Therefore, an object of the present invention is to provide a data analysis system and the like capable of accurately evaluating the relevance of analysis target data to a predetermined case.

The above-mentioned object is attained by a data analysis system for analyzing data, wherein the data analysis system includes: a memory configured to at least temporarily store a plurality of pieces of evaluation data which is a target to be analyzed; and a controller configured to evaluate the plurality of pieces of evaluation data on the basis of learning data, wherein the controller is configured to: extract a plurality of components from the learning data, each of the plurality of components constituting at least part of the learning data; select a component to be utilized for evaluation of the plurality of pieces of evaluation data, from among the plurality of components, on the basis of evaluation information about each of the plurality of extracted components; and evaluate the evaluation data by utilizing the selected component.

According to the above-mentioned disclosure, a data analysis system and the like capable of accurately evaluating the relevance of analysis target data to a predetermined case are provided.

### BRIEF DESCRIPTION OF THE DRAWINGS

FIG. 1 is a block diagram showing an example of a hardware configuration of a data analysis system;

FIG. 2 is a diagram illustrating the arrangement of components in learning data;

FIG. 3 is a characteristic diagram showing a distribution of evaluation values of a plurality of components and occurrence positions thereof in learning data;

FIG. 4 is an example of a flowchart executed when a server device evaluates evaluation target data;

FIG. 5 is an example of a flowchart for the server device to extract a synonym from evaluation target data; and

FIG. 6 is a management table showing a list of synonym candidates for each data pattern of a related morpheme.

FIG. 7 is a flowchart for integrating component groups.

FIG. 8 is a control table for component group integration processing.

### DETAILED DESCRIPTION OF THE PREFERRED EMBODIMENTS

### [Configuration of Data Analysis System]

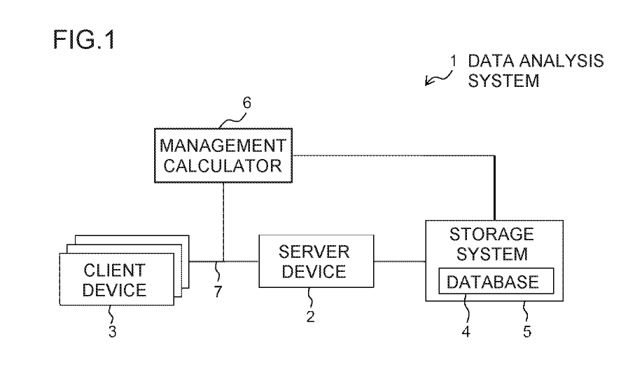

FIG. 1 is a block diagram showing an example of a hardware configuration of a data analysis system (which may be hereinafter referred to simply as the “system”) according to this embodiment. The system includes any recording medium (e.g., a memory, a hard disk, etc.) capable of storing, for example, data (including digital data and/or analog data), and a controller (e.g., a CPU; Central Processing Unit) capable of executing a control program stored in the recording medium. The system can be implemented as a computer or a computer system which analyzes data at least temporarily stored in the recording medium, or a computer system (a system that implements a data analysis by allowing a plurality of computers to operate in an integrated manner).

In this embodiment, for example, “learning data” (training data) may be presented to a user as reference data, and the data (classified reference data, a combination of reference data and classification information) may be associated with classification information. The learning data can also be referred to as “teacher data” or “training data”. The “evaluation target data” (evaluated data) may be data that is not associated with the classification information (which is not presented to the user as reference data, and the data may be unclassified data or “unknown data” for the user). In this case, the above-mentioned “classification information” may be an identification label used for arbitrarily classifying the reference data. The classification information may be, for example, information for classifying the reference data into any number of (e.g., two) groups such as a “Related” label indicating that the reference data is relevant to a predetermined case (the above-mentioned system includes a wide range of targets for which the relevance to the data is evaluated, and the range is not limited), and a “Non-Related” label indicating that the data and the predetermined case are not related to each other.

As illustrated in FIG. 1, the above-mentioned system may include, for example, a server device (server calculator) 2 which is capable of executing primary processing for a data analysis, one or more client devices (client calculators) 3 which are capable of executing processing related to the data analysis, a storage system 5 including a database 4 for recording data and results of evaluation of the data, and a management calculator 6 which provides the client devices 3 and the server device 2 with a management function for the data analysis. These devices may include, as hardware resources, for example, a memory, a controller, a bus, an input/output interface (e.g., a keyboard, a display, etc.), and a communication interface (which connects the devices by communication means using a predetermined network so that the devices can communicate with each other) (the devices are not limited to these examples). The server device 2 includes (non-transitory) storage media, such as a hard disk, a flash memory, a DVD, a CD, and a BD, which store programs and data necessary for the data analysis.

The client devices 3 each present to the user a part of data as reference data. This allows the user to perform, as an evaluator (or a viewer), input (provide classification information) for evaluation and classification of the reference data via the client devices 3. The server device 2 learns, from the data, patterns (e.g., a wide variety of patterns, such as abstract rules, meanings, concepts, styles, distributions, and samples, which are included in the data, and the patterns are not limited to so-called “specific patterns”) based on a combination of the reference data and the classification information (learning data), and evaluates the relevance of the evaluation target data to the predetermined case based on the learned patterns.

The management calculator 6 executes predetermined management processing on the client devices 3, the server device 2, and the storage system 5. The storage system 5 may include the database 4 which is composed of, for example, a disk array system and stores data and results of evaluation and classification of the data. The server device 2 and the storage system 5 are connected by a DAS (Direct Attached Storage) system or SAN (Storage Area Network) so that the server device 2 and the storage system 5 can communicate with each other.

The hardware configuration shown in FIG. 1 is illustrated by way of example of only. The above-described system may be, for example, replaced by another hardware configuration. For example, a part or the whole of the processing executed in the server device 2 may be executed in the client devices 3; a part or the whole of the processing may be executed in the server device 2; and the storage system 5 may be incorporated in the server device 2. The user may perform input (provide classification information) for evaluation and classification of sample data via the client devices 3, and may also perform the input via an input device which is directly connected to the server device 2. It is understood by those skilled in the art that there are various hardware configurations capable of implementing the system, and the system is not limited to one specific configuration (e.g., the configuration as illustrated in FIG. 1).

### [Data Evaluation Function]

The system may include a data evaluation function. The data evaluation function is a function for evaluating a large number of pieces of evaluation target data (big data) based on a small number of pieces of data (learning data) which are manually classified. The provision of the data evaluation function enables the system to implement the evaluation by deriving, for example, an index indicating the level (high or low) of the relevance of the evaluation target data to the predetermined case (e.g., a value (e.g., a score) with which the evaluation target data can be ranked), text (e.g., “High”, “Middle”, or “Low”), and/or a symbol (e.g., “⊚”, “∘”, “Δ”, or “x”)). The data evaluation function is implemented by the controller of the server device 2.

When the system derives a score as the index for the evaluation, the system may calculate the score by any method. For example, the score may be calculated based on various methods used in the field of machine learning or natural language processing (e.g., a method using a k-nearest neighbor algorithm, a method using support vector machine, a method using a neural network, a method for assuming a statistical model for data (e.g., a method using a Gaussian process), and/or a method using a combination thereof), or may be calculated based on various methods used in the field of statistics (e.g., based on a frequency of occurrence of a component in data).

A “component” (which may be referred to as a data element) may be partial data constituting at least a part of data, and is, for example, a morpheme, a keyword, a sentence, a paragraph, and/or metadata (e.g., header information of an e-mail) which constitutes a document; partial sound constituting sound, volume (gain) information, and/or tone information; a partial image constituting an image, a partial pixel, and/or luminance information; and a frame image constituting a video, motion information, and/or three-dimensional information.

When the system calculates the score based on a frequency of occurrence of a component in data, for example, the following calculation method may be employed. First, the system extracts the component constituting learning data from the learning data, and evaluates the component. At this time, the system evaluates, for example, a degree of contribution of each of a plurality of components constituting at least a part of the learning data to the combination of the data and the classification information (in other words, a frequency of occurrence of the components according to the classification information). The degree can also be referred to as a weight. In a more specific example, the system evaluates the components using trans-information (e.g., information calculated by a predetermined formula using a probability of occurrence of the components and a probability of occurrence of the classification information), thereby calculating an evaluation value as evaluation information about the components in accordance with the following Formula 1.

wgt_{i,L}=\sqrt{wgt_{L-i}²+γ_{L}wgt_{i,L}²−θ}=\sqrt{wgt_{i,L}²+Σ_{ι=1}^{L}(γ_{L}wgt_{i,L}²−θ)} [Formula 1]

In the formula, wgt represents an initial value of an evaluation value of an i-th component before evaluation; wgt represents the evaluation value of the i-th component after an L-th evaluation; γ represents an evaluation parameter in the L-th evaluation; and θ represents a threshold used in the evaluation. Thus, the system can evaluate each component in such a manner that, for example, the larger the calculated value of the trans-information is, the more the component represents a predetermined characteristic of the classification information.

Next, the system associates the components with the evaluation values and stores the components and the evaluation values in any memory (e.g., the storage system 5). Further, the system extracts a component from evaluation target data and confirms whether the component is stored in the memory. When the component is stored in the memory, the system reads out, from the memory, the evaluation value associated with the component, and evaluates the evaluation target data based on the evaluation value. In a more specific example, the system calculates the following formula using the evaluation value associated with the component constituting at least a part of the evaluation target data, thereby making it possible to calculate the score.

Scr=Σ_{ι=0}^{N}i*(mᵢ+wgtᵢ²)/Σᵢ₌₀^{N}i*wgtᵢ² [Formula 2]

mⱼ: the occurrence frequency of the i-th component; wgtᵢ: the evaluation value of the i-th component

The server device 2 may continue (repeat) the extraction and evaluation of the components until a recall rate reaches a predetermined target value. The recall rate is an index indicating a percentage (completeness) of data to be found in a predetermined number of pieces of data. For example, assuming that data is relevant to the predetermined case when the recall rate is 80% with respect to the entire data of 30%, 80% of the data is included in a higher 30% of the index (score). When a round-robin (linear review) of data is performed by a person without using any data analysis system, the amount of data to be found is in proportion to the amount of data reviewed by the person. Accordingly, as a divergence from the proportion increases, a more excellent data analysis performance of the system is obtained.

The implementation examples of the data evaluation function described above are illustrated by way of example only. Specifically, the specific mode of the data evaluation function is not limited to one specific configuration (e.g., the score calculation method described above), as long as the data evaluation function is a function for “evaluating evaluation target data based on learning data”.

### [Optimization of Components]

For example, evaluation values of components extracted from the learning data are used to evaluate the evaluation data as described above. In this case, even regarding components of low evaluation values, if a large number of such components are included in the evaluation data, such evaluation data may be highly valued regardless of the true relevance between the evaluation data and a predetermined case.

So, in this embodiment, the above-described system optimizes components by, for example, selecting, determining, or extracting components to be used to evaluate the evaluation data, from among the components extracted from the learning data, on the basis of a mode of distribution of the extracted components in the relevant learning data and then evaluates the evaluation data on the basis of the selected components. Accordingly, the system can, for example, accurately judge, determine, and classify the relevance between the evaluation data and the predetermined case. Regarding components which are not selected, all of them may not be used for the evaluation of the evaluation data, or some of the components may be used for the evaluation of the evaluation data and the rest of them may not be used for the evaluation of the evaluation data. The server device 2 may, for example, other than directly utilizing the evaluation values of the selected component to evaluate the evaluation data, re-evaluate the selected components to evaluate the evaluation data or perform some processing such as increasing the evaluation values of the selected components to evaluate the evaluation data.

The server device 2 utilizes the mode of distribution of the plurality of extracted components in the learning data in order to select components. For example, a plurality of components having a predetermined positional relationship and existing in the learning data can be selected from the plurality of components extracted from the learning data on the basis of the mode of distribution. Preferably, the distribution of the evaluation values of the plurality of respective components and the occurrence positions of the plurality of respective components in the learning data can be utilized. This will be explained below in detail.

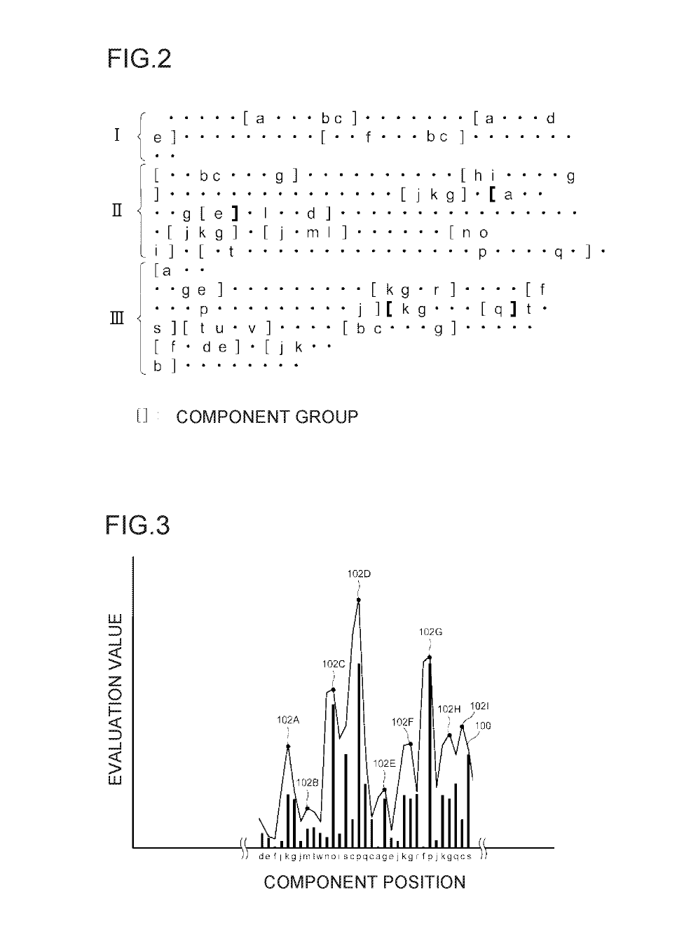

FIG. 2 shows an example of the learning data. Each of alphabets, such as “a”, “b”, and “c”, corresponds to a component and “•” corresponds to a word that is not extracted as a component, such as a postpositional particle or an adverb. FIG. 3 shows a distribution of evaluation values of a plurality of respective components and the occurrence positions of the plurality of respective components in the learning data. The vertical axis represents the evaluation value of a component and the horizontal axis represents the occurrence position of the component in the learning data. Each bar indicates an evaluation value of the relevant component. When smoothing processing is performed on evaluation values of the plurality of components by using, for example, a Gaussian filter, the characteristic represented by reference numeral 100 is obtained.

According to this characteristic 100, the dominance (e.g., whether the evaluation value is high or low) of the components included in the learning data can be visualized. It indicates that components located at peaks (102A to 102I) are components that strongly characterize a combination of data and classification information (e.g., elements which are highly relevant to the predetermined case). Under this circumstance, other components having a predetermined positional relationship with the relevant component (hereinafter referred to as the “specific component”) (for example, components located in the vicinity of the specific component such as components located adjacent to the specific component) are also affected by the component located at the peak (the specific component), that is, have meanings or significance relevant to the specific component. Thus, it can be said that such other components are highly relevant to the predetermined case.

So, the server device 2 selects components focused on the peaks of the evaluation values in the distribution of evaluation values of the components with respect to the occurrence positions of the components in the learning data. For example, the server device 2 extracts, as a “component group”, a group of a component corresponding to a peak and components occurring before and after that component. The term “component group” used herein refers to, for example, a group of a plurality of components occurring at locations adjacent to each other in the learning data. In FIG. 3, the component group is indicated by an area surrounded by “[ ]”. For example, assuming that “a”, “b”, and “c” occur in the order of “a••b••c” in the evaluation data and the peak of the evaluation value is located at “b”, the component group may be defined by “a, b, c”. There is no need to consider words with no meaning (such as “•” as described earlier) between the components with respect to the component group.

Since a plurality of peaks may sometimes exist as can be seen from FIG. 3, as many component groups as the number of peaks may exist. The server device 2 may utilize all the component groups to evaluate the evaluation data or utilize some component groups based on whether the evaluation values of the peaks are large or small.

The server device 2 selects components to be included in a component group from, for example, components included in the learning data and evaluates the evaluation data on the basis of the selected components. When this happens, for example, when the difference (distance) between the occurrence positions of the components constituting the component group is small in the evaluation data, the server device 2 may increase the evaluation value of the evaluation data more than a case where the above-described difference (distance) between the occurrence positions of the components is large; and when a plurality of components occur in the evaluation data in such a manner as to constitute a group, the server device 2 may increase the evaluation value of the evaluation data more than a case where a plurality of components do not occur in the evaluation data in such a manner as to constitute a group.

### [Evaluation of Evaluation Target Data by the Server Device 2]

The operation of evaluating evaluation target data by the server device 2 will be described. FIG. 2 is a flowchart of the server device 2 (specifically, the controller of the server device 2). The server device 2 acquires, as reference data, one or more pieces of data from the evaluation target data recorded in the storage system 5 (step S300: a reference data acquisition module). Each step can also be referred to as a module or means as mentioned above.

Next, the user actually reviews the reference data and determines the classification, and the server device 2 acquires, from any input device, the classification information input for the reference data by the user (step S302: a classification information acquisition module). The server device 2 forms learning data by combining the reference data and the classification information, and extracts a component from the learning data (step S304: a component extraction module).

Further, the server device 2 evaluates the component (step S306: a component evaluation module), associates the component with the evaluation value, and stores the component and the evaluation value in the storage system 5 (step S308: a component storage module). The processing of steps S300 to S308 described above corresponds to a “learning phase” (a phase at which the artificial intelligence learns patterns). Instead of creating the learning data from the reference data, the learning data may be prepared in advance. For example, in the case of searching for a publicly-known document for invalidating a patent related to a certain patent right, the learning data is a combination of the description of the scope of claims and the “Related” label.

The controller creates distribution of the evaluation values of components and the occurrence positions of the components with respect to the plurality of components extracted from the learning data (FIG. 2) (S310: a component distribution creation module) and further judges peaks of the evaluation values of the components from the distribution as described earlier (S312: a distribution processing module). Then, the controller selects a component group on the basis of the judged peaks (S314: component group selection module) and records components belonging to the selected group and their evaluation values in the storage system 5.

Next, the server device 2 acquires evaluation target data from the storage system 5 (step S316: an evaluation target data acquisition module). Further, the server device 2 reads out a component and the evaluation value of the component from the storage system 5, and extracts the component from the evaluation target data (step S318: a component extraction module). The server device 2 evaluates the evaluation target data based on the evaluation value associated with the component (step S320: an evaluation target data evaluation module), and creates ranking information (ranking) of the plurality of pieces of evaluation target data. The higher-order evaluation target data indicates a higher relevance to the predetermined case. The processing of step S310 and subsequent steps corresponds to an evaluation phase for the learning phase. It should be noted that each process included in the flowchart described above is illustrated by way of example only and is not intended to indicate a limited mode.

According to the above-described embodiment, the evaluation data can be evaluated by selecting components which are highly relevant to the predetermined case, from among components extracted from the learning data, so that data related to the predetermined case can be found accurately.

### [Determination of Synonymous Component]

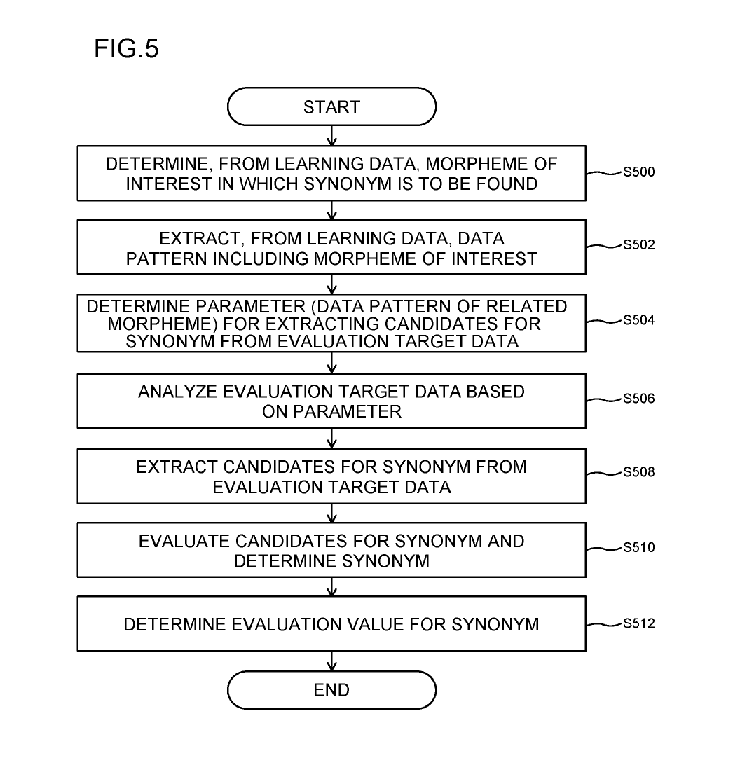

In the evaluation of the evaluation target data, it is important for the server device 2 to review whether or not evaluation target data includes a component that is the same as a component of learning data, as well as components related to the component of the learning data, in particular, a synonym for a morpheme of the learning data, in order to reasonably evaluate the evaluation target data. Conventional data analysis systems have attempted to extract a synonym for a morpheme of learning data from evaluation target data without depending on an evaluator. However, the synonym is still insufficient, so that the accuracy of the evaluation of the evaluation target data is also insufficient. Accordingly, the data analysis system of this embodiment extracts, from the learning data, a data pattern including a predetermined component of the learning data, determines a plurality of candidates for a synonymous component from the evaluation target data based on the data pattern, evaluates the plurality of candidates, and determines the component synonymous with the predetermined component according to the evaluation result. FIG. 5 is a flowchart for the above-mentioned process. The server device 2 can execute the flowchart in step S320, which is described above, in accordance with a synonymous component determination program. The flowchart will be described in detail below. Note that in this embodiment, the term “synonym” refers to words which have different word forms but have the same (or similar) meaning. However, the definition of the term “synonym” is not limited to this. For example, the term “synonym” may refer to words (related words) related based on certain standards. The definition of “synonym” may be determined as appropriate by the user.

A morpheme of interest from which a synonym is to be found is determined from learning data (S500). The morpheme (morpheme of interest) from which a synonym is to be found from the learning data may be selected as needed by an evaluator, an administrator, or a user of the analysis target system. Preferably, a morpheme with a most significant evaluation value, or a morpheme with a higher-order evaluation value may be selected as the morpheme of interest. A plurality of morphemes of interest may be selected.

A data pattern including the morpheme of interest is extracted from the learning data (S502). The server device 2 can use a distribution mode of the morpheme of interest in learning data as an example for extracting a data pattern (first data pattern) including the morpheme of interest from the learning data as mentioned earlier. Note that the mode of the first data pattern is not limited to a specific mode. Any mode may be used, as long as the mode can specify a related morpheme incidental to the morpheme of interest as described later.

According to the aforementioned characteristic 100 (FIG. 2), the dominance of each morpheme included in the learning data can be visualized, which is advantageous for the server device 2 to extract, determine, or judge the data pattern including the morpheme of interest. The server device 2 selects a morpheme based on the peak of each evaluation value in the distribution of the morphemes and evaluation values in the learning data. The server device 2 extracts, as “morpheme group”, a group of a morpheme corresponding to a peak and morphemes occurring before and after the morpheme.

A parameter for extracting a synonym candidate (a data pattern for a related morpheme) from the evaluation target data is determined (S504).

The server device 2 extracts, from the learning data, a morpheme group including the morpheme of interest as a data pattern including the morpheme of interest. This data pattern (first data pattern) indicates a combination of a morpheme of interest and a plurality of morphemes incidental to the morpheme of interest. In this case, the morphemes occurring in the same data pattern incidentally to the morpheme of interest are morphemes related to the morpheme of interest. Accordingly, synonyms that are not included in the learning data, or synonyms that are included in the learning data and given a low evaluation can be found out from the evaluation target data by following the data pattern of a combination of a plurality of related morphemes. Accordingly, the server device 2 executes a search for a synonym from a plurality of pieces of evaluation target data using a data pattern based on the related morphemes (i.e., the second data pattern including the combination of the plurality of related morphemes) as a key (parameter).

The above-mentioned process will be described in detail below. The first data pattern: (M₁, Mₒ, M₂), (M₃, Mₒ, M₄), (M₅, Mₒ, M₆) . . . .

Symbols in brackets indicate the first data pattern extracted from the learning data; Mₒ represents the morpheme of interest; and M₁, M₂, M₃, M₄, M₅, M₆ . . . other than Mₒ represent related morphemes.

When a plurality of morpheme groups including the morpheme of interest is present, a plurality of data patterns of related morphemes as described below is present.

Related morpheme data pattern (second data pattern): (M₁, M₂), (M₃, M₄), (M₅, M₆) . . . .

The server device 2 compares a plurality of second data patterns with a plurality of pieces of evaluation target data, respectively, and specifies the evaluation target data including the second data patterns. In this case, the entire evaluation target data may be specified, or a part of the evaluation target data may be specified. For example, when the evaluation target data is a text file, the object to be specified may include not only a text file, but also a part of the text file, such as a paragraph, a sentence, or a page. The evaluation target data is not limited to a text file, but instead may be a paragraph, a sentence, a page, or the like.

The evaluation target data is analyzed based on the parameter (S506).

When the data pattern of the related morpheme is represented by (M₁, M₂), the server device 2 extracts the evaluation target data including M₁ and M₂ as morphemes from a data set (population) including the plurality of pieces of evaluation target data. In this case, it is considered that the extracted evaluation target data is relevant to the morpheme of interest (Mₒ) via the related morpheme data pattern (M₁, M₂), and thus it is expected or assumed that the extracted evaluation target data includes synonym candidates for the morpheme of interest. Accordingly, the server device 2 performs differential processing on the extracted evaluation target data as described later, and synonym candidates for the morpheme of interest can be extracted, selected, detected, identified, specified, determined, or judged from the morphemes included in the extracted evaluation target data.

(A plurality of) synonym candidates are extracted from the evaluation target data (S508). The server device 2 extracts the synonym candidates by performing differential processing on the extracted evaluation target data. The server device 2 extracts the synonym candidates as follows.

(1) The server device 2 first extracts morphemes from the extracted evaluation target data.

(2) If the extracted morphemes include the morpheme of interest, the server device 2 excludes the morphemes. This is because the synonyms have a word form different from that of the morpheme of interest. For example, “physical examination” is set as the morpheme of interest, synonyms are “diagnosis”, “medical care”, and “examination”.

(3) The server device 2 excludes the related morphemes from the extracted morphemes. This is because the related morphemes are incidental to the morpheme of interest and are not sufficient as synonyms for the morpheme of interest. For example, when “physical examination” is set as the morpheme of interest, related morphemes are “internal medicine” and “hospital”.

The morphemes extracted by the processes (1) to (3) become synonym candidates for the morpheme of interest. However, there is a possibility that a large number of morphemes may be extracted as synonym candidates as a result of the above processes. Therefore, for example, when the number of the morphemes is equal to or greater than a predetermined reference value, the server device 2 may narrow down the candidate morphemes by, for example, at least one of the following processes.

A Exclude a morpheme included in learning data from synonym candidates.
B Exclude a morpheme that is used in a manner different from that of the morpheme of interest from the synonym candidates. For example, when the morpheme of interest is present as a subject in the learning data and the morpheme is present as an object in the evaluation target data, the latter one is excluded from the synonym candidates.
C Exclude general terms, such as “device”, “machine”, and “calculator”, from the synonym candidates.
D Exclude a morpheme having a co-occurrence relation with the morpheme of interest from the synonym candidates. This is because the morpheme having the co-occurrence relation occurs in the learning data incidentally to the morpheme of interest, and thus is different from synonyms that are not included in the learning data.
E Narrow down the synonym candidates to morphemes that are highly relevant to the related morphemes. For example, a morpheme group including the related morphemes is extracted from the extracted evaluation target data, and the morphemes extracted as synonym candidates are set as the morphemes included in the morpheme group.

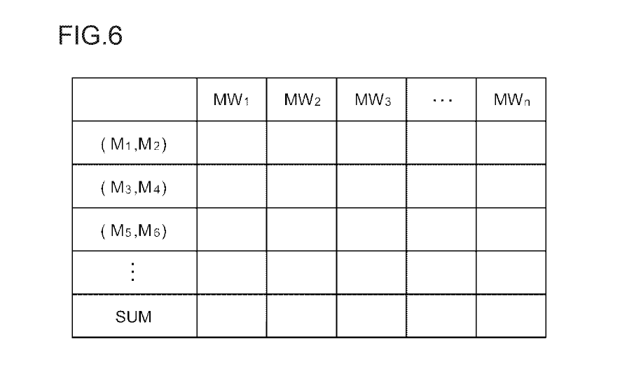

When the server device 2 determines synonym candidates by comparing the data pattern of the related morphemes with one piece of evaluation target data, the server device 2 repeats the process for the remaining evaluation target data. In this manner, synonym candidates for one morpheme group are determined. Further, the server device determines synonym candidates for the data pattern of the remaining related morphemes, thereby making it possible to obtain a list of the synonym candidates for the learning data. FIG. 6 is a management table showing a list of synonym candidates (MW₁, MW₂, MW₃, . . . , MWₙ) for each data pattern of the related morphemes. This management table may be stored in the database 4.

The synonym candidates are evaluated and synonyms are determined (S510). Next, the server device 2 evaluates a plurality of synonym candidates and determines morphemes to be synonyms from among the plurality of synonym candidates. The server device 2 evaluates the synonym candidates based on the occurrence frequency of the synonym candidates as an example of evaluating the synonym candidates. Specifically, as shown in FIG. 6, the server device counts the number of occurrence of the synonym candidates in the plurality of pieces of evaluation target data for each data pattern of the related morphemes, and determines, based on a total value (SUM) obtained by calculating the total value of the synonym candidates for the plurality of related morpheme data patterns, that a morpheme with a larger total value indicates that the morpheme is more suitable as a synonym.

The server device 2 determines a predetermined number of (one or more) morphemes to be synonyms according to ranking in a descending order of the total values of the synonym candidates. For example, the determination is made using a most significant morpheme as a synonym, or the determination is made using morphemes from the most significant morpheme to a morpheme of a predetermined rank as synonyms. There is a possibility that in the higher order of ranking, the morphemes may occur not as synonym candidates but as morphemes used widely in the evaluation target data. Therefore, if there is such a possibility, synonyms may be determined by excluding morphemes in a predetermined range of higher-order morphemes in the ranking. The determination of synonyms based on ranking may be made by the server device 2, or the determination of synonyms may be made by the user.

Evaluation values for the synonyms are determined (S512).

When the server device 2 determines a target morpheme as a synonym for the morpheme of interest, the server device 2 determines the evaluation value of the target morpheme. The evaluation value of the target morpheme may be based on, for example, the evaluation value of the morpheme of interest. The evaluation value of the target morpheme may be the same as the evaluation value of the morpheme of interest, or may be obtained by correcting the evaluation value of the morpheme of interest. Accordingly, the server device 2 can evaluate a plurality of pieces of evaluation target data based on the evaluation value of the target morpheme.

### [Integration of Component Groups]

This embodiment is characterized in that the learning data is divided into a plurality of segments by utilizing the evaluation results of the components included in the learning data and the plurality of respective segments are utilized as a plurality of pieces of new learning data in order to evaluate the evaluation data. The learning data can be divided into a plurality of segments by, for example, dividing components of the learning data into predetermined patterns on the basis of the mode of distribution of the components extracted from the learning data in the relevant learning data. Furthermore, specifically speaking, a plurality of segments can be set to the learning data by integrating a plurality of component groups selected from the learning data on the basis of the relevance with a predetermined case.

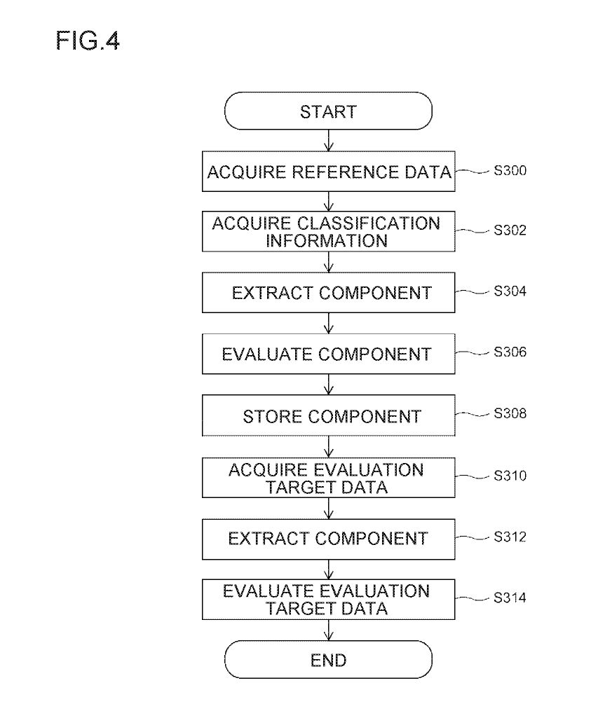

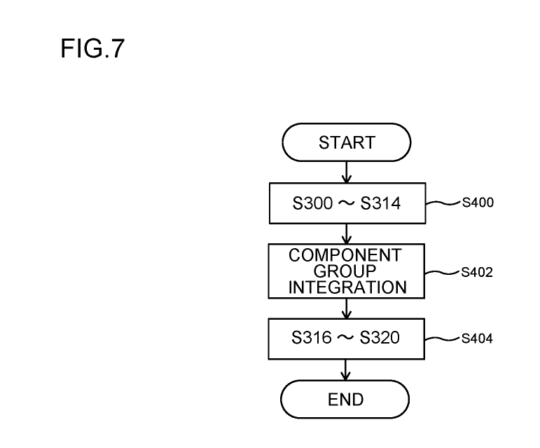

The operation of the data analysis system according to a second embodiment will be explained based on an operation flowchart of the controller for the server device 2 (FIG. 7). Processing executed by the controller until it selects a component group (S300˜S314) is the same as that in FIG. 4. In S400, the controller creates an integrated group by integrating component groups which are related to each other (component group integration). The component group integration will be specifically explained.

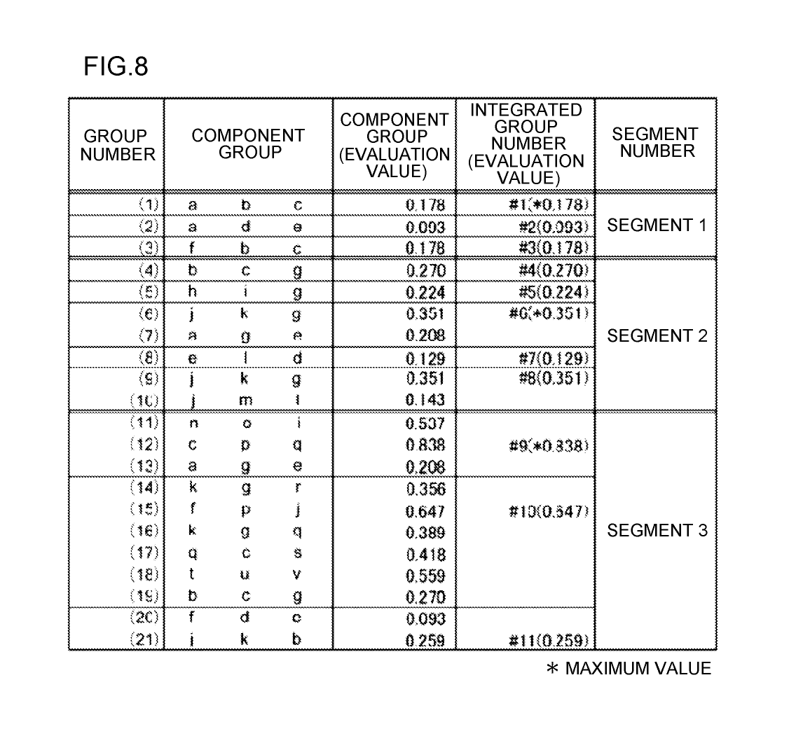

When component groups are related to each other, for example, when the component groups are located next to each other without intermediary of words which are not components (“•” as mentioned earlier), or when they are located next to each other with the intermediary of a small number of such words, or when the last components of the component groups and the first components of the component groups are the same term, it can be expected that the meanings, significance, etc. of the plurality of component groups may be related to each other. Therefore, the plurality of component groups are integrated to form an integrated group. The server device 2 stores the process of integration of the plurality of component groups in a control table in FIG. 8 and records it in a specified area of the memory.

Referring to FIG. 8, regarding each of component groups with group numbers (1) to (5), a single component group corresponds to an “integrated group” and component groups with group numbers (6) and (7) are integrated to form an integrated group #6; and the rest of the component groups are as illustrated in FIG. 8. In FIG. 8, a component group evaluation value is a maximum value as a representative value of evaluation values of a plurality of components which belong to a component group; and an integrated group evaluation value is a maximum value as a representative value of evaluation values of component groups which belong to an integrated group.

Even after integrating component groups, it is possible that performing only such integration may not be enough and the number of integrated groups (#1˜#11) may still be large. So, the controller further integrates the integrated groups (S402: integrated group integration). The controller finds peaks of maximum values (maximum values distinguished with “*” in FIG. 8) of the integrated groups from the distribution of the maximum values of the integrated groups and sets segments into which the integrated groups are integrated, with respect to each peak (segment setting). FIG. 8 shows that three segments 1, 2, and 3 are set to the learning data. Accordingly, the controller can divide the learning data into three segments, that is, I (Segment 1), II (Segment 2), and III (Segment 3) as illustrated in FIG. 2.

Having proceeded to the evaluation of the evaluation data (S404 [S316 to S320]), the controller refers to the control table (FIG. 8) and evaluates the evaluation data on the basis of the three segments. As the number of pieces of the learning data increases, the aforementioned recall rate can be enhanced. When evaluating the evaluation data, the controller may utilize components of each of a plurality of trainings and their evaluation values or may extract new components from each piece of the learning data and find and utilize their evaluation values.

### [Data Format Processed by the Data Analysis System]

In this embodiment, “data” may be any data represented by a format that can be processed by a computer. The above-mentioned data may include various data (the data is not limited to these examples) such as unstructured data in which the definition of the structure in at least a part of the data is incomplete, document data (e.g., e-mail (including an attachment and header information) including at least partially a text described by a natural language, technical documents (e.g., a wide variety of documents for explaining technical matters, such as academic papers, patent gazette, product specifications, or design), presentation materials, spreadsheet materials, financial statements, meeting materials, report, business materials, contract, organization chart, business plan, corporate analysis information, electronic health record, web page, blog, and comments posted on social network services), audio data (e.g., data obtained by recording conversation, music, or the like), image data (e.g., data composed of a plurality of pixels or vector information), and video data (e.g., data composed of a plurality of frame images).

For example, when document data is analyzed, the system can extract, as a component, a morpheme included in document data which is learning data, evaluate the components, and evaluate the relevance of the document data to the predetermined case based on the components extracted from the document data as the evaluation target data. When audio data is analyzed, the system may use the audio data itself as an analysis target, or may convert the audio data into document data by voice recognition and use the converted document data as an analysis target. In the former case, for example, the system can divide the audio data into parts with a predetermined length and use the parts as components, and can identify the partial sound by any sound analysis method (e.g., a hidden Markov model, a Kalman filter, etc.), thereby making it possible to analyze the audio data. In the latter case, sound can be recognized by any voice recognition algorithm (e.g., a recognition method using a hidden Markov model) and can be analyzed in the same procedure as that described above for the recognized data (document data). When image data is analyzed, for example, the system divides the image data into partial images with a predetermined size and identifies the partial images by any image recognition method (e.g., a pattern matching, support vector machine, a neural network, etc.), thereby making it possible to analyze the image data. Further, when video data is analyzed, for example, the system divides a plurality of frame images included in the video data into partial images with a predetermined size and uses the partial images as components, and identifies the partial images by any image recognition method (e.g., a pattern matching, a support vector machine, a neural network, etc.), thereby making it possible to analyze the video data.

When the system analyzes audio data, “synonymous component” may be a component whose phoneme group is similar to that of the selected predetermined component (e.g., partial sound). When the system analyzes image data or video data, “synonymous component” may be a component whose pixel group is similar to that of the selected predetermined component (e.g., partial images obtained by dividing a plurality of frame images into partial images with a predetermined size), or may be a component in which the same (or similar) subject occurs. However, the synonymous component is not limited to these examples.

### Implementation Examples Using Software/Hardware

The control block of the system may be implemented by a logic circuit (hardware) formed of an integrated circuit (IC chip) or the like, or may be implemented by software using a CPU. In the latter case, the system includes a CPU that executes a program (a control program for the data analysis system) as software for implementing each function; a ROM (Read Only Memory) or a storage device (these are referred to as a “recording medium”) which stores the program and various data so that the program and data can be read by a computer (or a CPU); and a RAM (Random Access Memory) for developing the program. The computer (or the CPU) reads the program from the recording medium and executes the program, thereby attaining the object of the present invention. As the recording medium, “non-transitory tangible media” such as tapes, disks, cards, semiconductor memories, or programmable logic circuits can be used. The program may be supplied to the computer via any transmission media (communication networks, broadcasting, etc.) which can transmit the program. The present invention can be implemented by a mode of a data signal buried in a carrier. The mode is embodied by electrical transmission of the program. The program can be implemented by any programming language. Any recording media storing the program are included in the scope of the present invention.

### Application Examples

The system described above can be implemented as an artificial intelligence system for analyzing big data (any system capable of evaluating the relevance of the data to the predetermined case), such as, for example, a discovery support system, a forensic system, an e-mail monitoring system, a medical application system (e.g., a pharmacovigilance support system, a system for promoting efficiency of clinical investigations, a medical risk hedge system, a fall prediction (fall prevention) system, a prognosis prediction system, and a diagnosis support system), Internet application system (e.g., a smart mail system, an information aggregation (curation) system, a user monitoring system, or a social media management system), an information leakage detection system, a project evaluation system, a marketing support system, an intellectual property evaluation system, an unauthorized trading monitoring system, a call center escalation system, or a credit investigation system. Depending on the fields to which the data analysis system of the present invention is applied, for example, preprocessing may be performed on data (e.g., an important section is extracted from the data and only the important section is used as the data analysis target) in consideration of the circumstances unique to the field, or the mode of displaying the data analysis result may be changed. It is understood by those skilled in the art that there are various modified examples and all modified examples are included in the scope of the present invention.

According to the embodiments explained above, the evaluation target data can be evaluated by utilizing the morpheme of interest itself or by determining synonyms by utilizing the morpheme of interest and on the basis of the synonyms, so that the relevance of the analysis target data to a predetermined case can be evaluated accurately. The present invention is not limited to the embodiments described above and can be modified in various ways within the scope of the claims. Embodiments obtained by combining technical means disclosed in different embodiments as appropriate are also included in the technical scope of the present invention. Furthermore, new technical features can be formed by combining the technical means disclosed in the embodiments.

What is claimed is:

1. A data analysis system for analyzing data, comprising:
a memory configured to at least temporarily store a plurality of pieces of evaluation data which is a target to be analyzed; and
a controller configured to evaluate the plurality of pieces of evaluation data on the basis of learning data,
wherein the controller is configured to:
extract a plurality of components from the learning data, each of the plurality of components constituting at least part of the learning data;
select a component to be utilized for evaluation of the plurality of pieces of evaluation data, from among the plurality of components, on the basis of evaluation information about each of the plurality of extracted components; and
evaluate the evaluation data by utilizing the selected component.

2. The data analysis system according to claim 1, wherein the selection of the component by the controller includes:
finding a mode of distribution of the plurality of components in the learning data from a relation between the evaluation information about each of the plurality of extracted components and an occurrence position of each of the plurality of components in the learning data; and
determining the component to be utilized for the evaluation of the plurality of pieces of evaluation data, from among the plurality of components, on the basis of the mode of distribution.

3. The data analysis system according to claim 1, wherein the controller selects, from the plurality of components extracted from the learning data and on the basis of the mode of distribution, a plurality of components which have a predetermined positional relationship and exist in the learning data, as the component to be utilized for the evaluation of the plurality of pieces of evaluation data.

4. The data analysis system according to claim 3, wherein the controller:
finds at least one peak of the evaluation information about the plurality of components extracted from the learning data on the basis of the mode of distribution; and
selects the component to be utilized for the evaluation of the plurality of pieces of evaluation data from among the plurality of components on the basis of the peak.

5. The data analysis system according to claim 1
wherein the controller is configured to:
extract a first data pattern including the selected component from the learning data;
search each of the plurality of pieces of evaluation target data based on a second data pattern related to the first data pattern;
extract evaluation target data including the second data pattern; and
determine a component synonymous with the selected component based on a difference between the extracted evaluation target data and the first data pattern.

6. The data analysis system according to claim 5, wherein the controller performs the determination of the synonymous component by
selecting, from the extracted evaluation target data, a plurality of candidates for the component synonymous with the predetermined component based on the difference between the extracted evaluation target data and the first data pattern,
evaluating the plurality of candidates for the synonymous component, and
determining, based on the evaluation, the component synonymous with the predetermined component among the plurality of candidates for the synonymous component.

7. The data analysis system according to claim 5, wherein the controller is further configured to:
set, as the learning data, a combination of reference data presented to a user and classification information set to the reference data by the user;
generate evaluation information about the plurality of components based on a degree of contribution of the plurality of components to the combination; and
evaluate the plurality of pieces of evaluation target data by generating an index for ranking the plurality of pieces of evaluation target data based on the generated evaluation information.

8. The data analysis system according to claim 5, wherein the controller determines the first data pattern based on a mode of a distribution of the plurality of components in the learning data.

9. The data analysis system according to claim 8, wherein the controller obtains the distribution from a relation between evaluation information about the plurality of components and positions of occurrence of the plurality of components in the learning data.

10. The data analysis system according to claim 8, wherein
the controller sets, as the first data pattern, a combination of the predetermined component and another component incidental to the predetermined component, based on the distribution, and
the second data pattern includes the other component.

11. The data analysis system according to claim 10, wherein the controller sets the other component based on a positional relationship based on the distribution of the predetermined component.

12. The data analysis system according to claim 6, wherein the controller
excludes a component included in the first data pattern from components included in the extracted evaluation target data to obtain the difference between the extracted evaluation target data and the first data pattern, and
selects a candidate for the synonymous component from among the components included in the extracted evaluation target data obtained after excluding the component.

13. The data analysis system according to claim 7, wherein the controller
determines evaluation information about the synonymous component based on evaluation information about the predetermined component, and
evaluates the plurality of pieces of evaluation target data based on the evaluation information about the synonymous component.

14. A control method for a data analysis system for evaluating a plurality of pieces of evaluation data on the basis of learning data,
the method comprising the following steps executed by the data analysis system:
extracting a plurality of components from the learning data, each of the plurality of components constituting at least part of the learning data;
selecting a component to be utilized for evaluation of the plurality of pieces of evaluation data, from among the plurality of components, on the basis of evaluation information about each of the plurality of extracted components; and
evaluating the evaluation data by utilizing the selected component.

15. A non-transitory computer-readable recording medium having a program recorded therein, the program causing a computer to execute data analysis for evaluating a plurality of pieces of evaluation data on the basis of learning data,
wherein the program:
extracts a plurality of components from the learning data, each of the plurality of components constituting at least part of the learning data;
selects a component to be utilized for evaluation of the plurality of pieces of evaluation data, from among the plurality of components, on the basis of evaluation information about each of the plurality of extracted components; and
evaluates the evaluation data by utilizing the selected component.
